(19) United States
(12) Patent Application Publication
(10) Pub. No.: US 2026/0177893 A1
(43) Pub. Date: Jun. 25, 2026

(54) IMAGE CAPTURING DEVICE, MOBILE PLATFORM IMAGE CAPTURING DEVICE, AND METHOD FOR CONTROLLING IMAGE CAPTURING DEVICE

(71) Applicant: CANON KABUSHIKI KAISHA, Tokyo (JP)

(72) Inventor: Rentaro IMAI, Kanagawa (JP)

(21) Appl. No.: 19/402,501

(22) Filed: Nov. 26, 2025

(30) Foreign Application Priority Data
Dec. 19, 2024 (JP) 2024-224213

(51) Int. Cl. G03B 17/56; G02B 27/64; H04N 23/68

(52) U.S. Cl. CPC G03B 17/561; G02B 27/646; H04N 23/6812; H04N 23/685

(57) ABSTRACT

An image capturing device 1, which is mountable on a mobile platform having first stabilization unit, has second stabilization unit for performing blur correction by driving a stabilization member, and an image capturing control unit 130 controlling the second stabilization unit using a first stabilization mode or a second stabilization mode which is targeted for blur correction at a frequency band higher than a frequency band targeted for blur correction by the first stabilization mode. The image capturing control unit 130 controls the second stabilization unit to be the first stabilization mode or the second stabilization mode in accordance with at least one of the presence or absence of the image capturing device 1 being mounted on the mobile platform and detected vibration.

### BACKGROUND

### Field of the Technology

The present disclosure relates to an image capturing device, a mobile platform image capturing device, and a method for controlling an image capturing device.

### Description of the Related Art

In the related art, in video production, a person holding an image capturing device captured video images while moving. Various image capturing forms, such as mounting an image capturing device on a stabilization device for reducing blur in images during movement and mounting an image capturing device on a gimbal head, have also been adopted. Recently, regarding these image capturing forms, devices capable of capturing images even in a state where an image capturing device is mounted on a mobile platform have been proposed. For example, Japanese Patent Laid-Open No. 2021-189368 discloses a technology for combining and optimizing blur correction in an image capturing system provided with an image capturing device and a gimbal rotatably supporting the image capturing device.

However, with the technology in the related art disclosed in Japanese Patent Laid-Open No. 2021-189368, when mounted on a mobile platform, there is concern that it may not be possible to capture high-quality video images due to an influence of vibration occurring while the mobile platform is moving.

### SUMMARY

According to the present disclosure, blur in images captured by an image capturing device mounted on a mobile platform is reduced.

According to the present disclosure, an image capturing device, which is mountable on a mobile platform having first stabilization unit, the device comprising: second stabilization unit configured to perform blur correction by driving a stabilization member; and at least one processor and memory holding a program which makes the processor function as a controller configured to control the second stabilization unit using a first stabilization mode or a second stabilization mode which is targeted for blur correction at a frequency band higher than a frequency band targeted for blur correction by the first stabilization mode, wherein the controller controls the second stabilization unit to be the first stabilization mode or the second stabilization mode in accordance with at least one of the presence or absence of the image capturing device being mounted on the mobile platform and detected vibration.

Features of the present disclosure will become apparent from the following description of embodiments with reference to the attached drawings. The following description of embodiments is described by way of example.

### BRIEF DESCRIPTION OF THE DRAWINGS

FIGS. 1A to 1C are views showing a constitution of a mobile platform image capturing device.

FIG. 2 is a view showing an example of functional blocks of the mobile platform image capturing device.

FIG. 3 is an explanatory view of a situation of blur correction of the mobile platform image capturing device in a pitch direction.

FIG. 4 is an explanatory view of frequency bands targeted for blur correction for each correction mode.

FIG. 5 is an explanatory view of variations in assignment of frequency bands in a second stabilization mode.

FIGS. 6A to 6D are explanatory views of a relationship between a movement direction of a mobile platform and vibration.

FIG. 7 is a flowchart showing control processing for blur correction in the image capturing device.

FIG. 8 is a view showing a large step on a path of the mobile platform.

### DESCRIPTION OF THE EMBODIMENTS

### First Embodiment

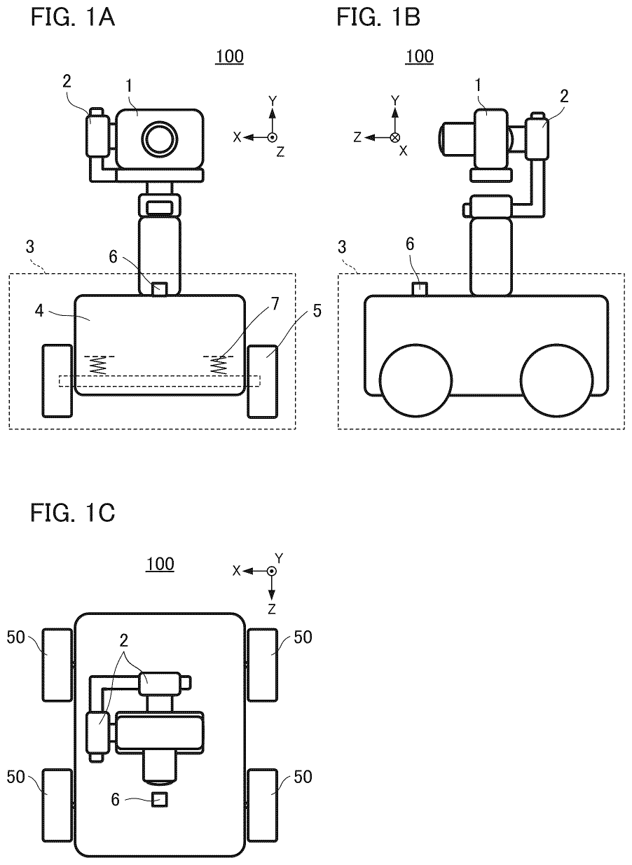

FIGS. 1A to 1C are views showing a constitution of a mobile platform image capturing device 100. The mobile platform image capturing device 100 is a mobile device which operates to capture images of a subject. The mobile platform image capturing device 100 includes an image capturing device 1, a gimbal 2 (mobile platform), and a mobile platform main body 3. In addition, the mobile platform image capturing device 100 of the present embodiment has stabilization unit for reducing blur occurring in images (video) captured by the image capturing device 1 in each of the image capturing device 1 and a mobile platform on which the image capturing device 1 can be mounted. Hereinafter, the stabilization unit provided in the mobile platform will be referred to as first stabilization unit, and the stabilization unit provided in the image capturing device 1 will be referred to as second stabilization unit.

The image capturing device 1 is an image capturing device intended to capture still images and moving images. The image capturing device 1 can control a plurality of parameters, such as an angle of view for image capturing, a focus position, and an exposure. For example, the image capturing device 1 is an interchangeable-lens digital single-lens camera. In the present embodiment, a case where the image capturing device 1 is an image capturing device in which a lens device (lens barrel unit) is detachably attached to a main body (image capturing unit) will be described. However, the image capturing device 1 may be an image capturing device in which a main body of the image capturing device and a lens device are integrated. The image capturing device 1 can be mounted on the gimbal 2 (mobile platform) and can also be used alone (hand-held image capturing or the like). The image capturing device 1 has the second stabilization unit for reducing blur occurring in captured images (video).

The mobile platform has the gimbal 2 and the mobile platform main body 3. The gimbal 2 detachably holds the image capturing device 1. For example, a method in which a tripod mount provided on a bottom surface of the image capturing device 1 is fixed to a fixing portion provided in the gimbal 2 is used. The gimbal 2 is a device for controlling an image capturing direction of the image capturing device 1 by rotatably supporting the image capturing device 1. In addition, the gimbal 2 functions as the first stabilization unit for reducing shaking propagated to the image capturing device 1 by rotatably supporting the image capturing device 1. For example, a hand-held gimbal is used as the gimbal 2. The gimbal 2 is detachably fixed to the mobile platform main body 3 using a screw or the like. In the present embodiment, the gimbal 2 and the mobile platform main body 3, which are integrated with each other, are treated as a mobile platform in a broad sense. The gimbal 2 may be a mobile platform which is not detachably attached with respect to the mobile platform main body 3.

The mobile platform main body 3 is means for moving the mobile platform image capturing device 100 and includes a housing 4, a movement mechanism 5, and a vibration sensor 6. In addition, the mobile platform main body 3 includes a suspension 7 connecting the housing 4 and the movement mechanism 5. The mobile platform main body 3 communicates with the outside so that it can be controlled from the outside. The housing 4 is an outer housing of the mobile platform main body 3 to which the gimbal 2 is fixed. A communication device, a control unit, a battery, and the like (not shown) are disposed inside the housing 4. In the present embodiment, a case where the housing 4 is a substantially rectangular parallelepiped will be described, but it is not limited thereto. The housing 4 may have various shapes, such as a polygonal shape or a shape in which curved surfaces are combined.

The movement mechanism 5 is disposed in a lower portion of the housing 4, and it is means for moving the mobile platform main body 3 in any direction. The movement mechanism 5 includes a plurality of wheels 50. The movement mechanism 5 is constituted to be able to move and rotate in all directions by controlling a rotation direction and a rotation speed of each wheel 50 using a Mecanum wheel mechanism in which a plurality of rollers are connected in a circumferential direction and rotatably held on each wheel 50. An axial direction, which is a direction connecting both end portions of an axle of the wheels 50, is an X axis direction. In FIGS. 1A to 1C, the plurality of rollers are omitted, and the wheels 50 are shown in simple cylindrical shapes. In addition, the housing 4 and the movement mechanism 5 are connected via the suspension 7 which can attenuate vibration during traveling by combining a spring, a rubber member, and the like. The vibration sensor 6 is disposed in an upper portion of the housing 4 and detects vibration propagated to the housing 4 during movement or the like of the mobile platform main body 3. The vibration sensor 6 (first sensor) is a device for measuring an angular velocity and an acceleration. For example, the vibration sensor 6 is an inertial measurement device such as a gyro sensor or an acceleration sensor.

FIG. 1A is a front view of the mobile platform image capturing device 100. FIG. 1B is a side view of the mobile platform image capturing device 100. FIG. 1C is a top view of the mobile platform image capturing device 100. A side in a traveling direction when the mobile platform image capturing device 100 moves forward in a forward direction will be defined as a positive Z axis direction, and a vertically upward direction perpendicular to the ground will be defined as a positive Y axis direction. In addition, a direction perpendicular to the Y axis direction and the Z axis direction, which is a direction to the left on the page in FIGS. 1A and 1C, will be defined as a positive X axis direction. That is, the Z axis extends in a front-rear direction (longitudinal direction) of the mobile platform main body 3, and the X axis extends in a lateral direction (short side direction) of the mobile platform main body 3. In a state where the image capturing device 1 shown in FIGS. 1A to 1C faces forward, an optical axis of an image capturing optical system of the image capturing device 1 is parallel to the Z axis. In the present embodiment, an example in which the movement mechanism 5 includes four wheels 50 is shown, but the number of wheels 50 is not limited thereto. The shape of the housing 4 is not limited to a rectangular parallelepiped and may be a sphere or a shape obtained by cutting away a part of a sphere.

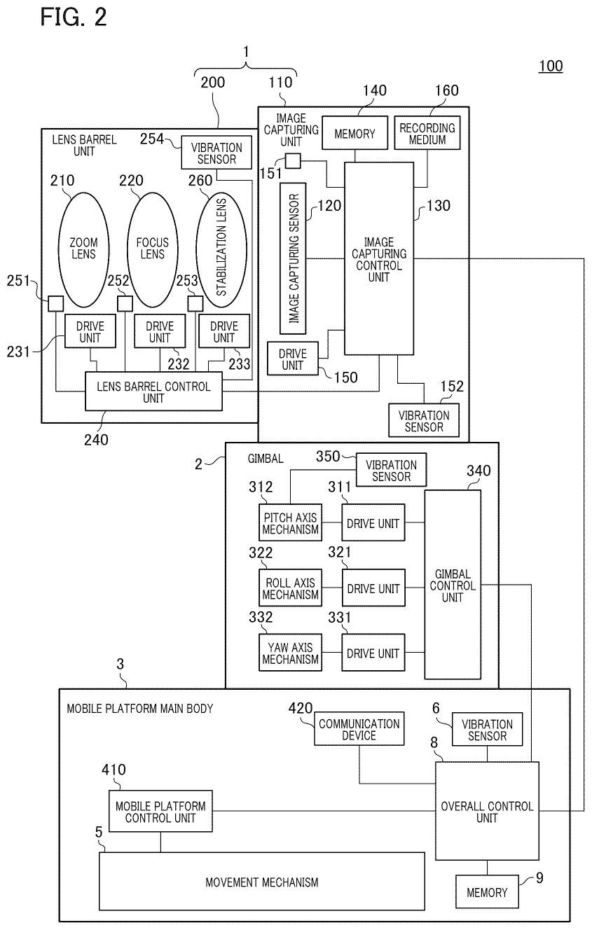

FIG. 2 is a view showing an example of functional blocks of the mobile platform image capturing device 100. The mobile platform image capturing device 100 includes the image capturing device 1, the gimbal 2, and the mobile platform main body 3. The image capturing device 1 includes an image capturing unit 110 and a lens barrel unit 200. The image capturing unit 110 is a camera main body. The lens barrel unit 200 (lens device) is detachably attached to the image capturing unit 110. In addition, the image capturing device 1 has the second stabilization unit for optically correcting blur by driving a stabilization member to reduce blur in captured images. The image capturing device 1 has a first stabilization mechanism in the image capturing unit 110 and a second stabilization mechanism in the lens barrel unit 200 as the second stabilization unit.

The image capturing unit 110 has an image capturing sensor 120, an image capturing control unit 130, a memory 140, and a recording medium 160. The image capturing sensor 120 is a photoelectric conversion element, which photoelectrically converts an optical image and outputs an output signal (analog signal) corresponding to the optical image. For example, the image capturing sensor 120 is constituted of a CCD or a CMOS. The image capturing sensor 120 outputs image data of an optical image formed through the lens barrel unit 200 to the image capturing control unit 130.

The image capturing control unit 130 controls the entirety of the image capturing device 1. For example, the image capturing control unit 130 is constituted of a microprocessor such as a central processing unit (CPU) or a micro-processing unit (MPU). In addition, the image capturing control unit 130 may be constituted of a microcontroller such as a micro-controller unit (MCU). In addition, the image capturing control unit 130 sends various instructions to a lens barrel control unit 240 controlling the lens barrel unit 200. When the image capturing device 1 is mounted on the gimbal 2 (mobile platform), the image capturing control unit 130 communicates with an overall control unit 8 of the mobile platform main body 3. In addition, the image capturing control unit 130 of the present embodiment controls the second stabilization unit using a first stabilization mode or a second stabilization mode, which will be described below.

The memory 140 stores programs and the like necessary for the image capturing control unit 130 to control the image capturing sensor 120 and the like. The memory 140 is a computer-readable recording medium. For example, the memory 140 includes at least one of an SRAM, a DRAM, an EPROM, an EEPROM, and a flash memory such as a USB memory. The image capturing control unit 130 realizes various control by loading and performing a program from the memory 140. The recording medium 160 records image data output by the image capturing sensor 120 to the image capturing control unit 130. For example, the recording medium 160 is a recording medium such as an SD card or a CF card. The recording medium 160 may be provided removably from the housing of the image capturing device 1.

The image capturing unit 110 has a body image stabilizer (BIS) which corrects blur occurring in captured images due to vibration applied to the image capturing unit 110 by driving the image capturing sensor 120 (stabilization member). More specifically, the image capturing unit 110 further includes a drive unit 150, a position sensor 151, and a vibration sensor 152, as the body image stabilizer. In the present embodiment, the BIS corresponds to the first stabilization mechanism. The vibration sensor 152 outputs a vibration signal (vibration value) corresponding to measured vibration in the image capturing unit 110. The vibration sensor 152 (third sensor) is a device for measuring an angular velocity and an acceleration. For example, the vibration sensor 152 is an inertial measurement device. The image capturing control unit 130 can acquire change in posture of the image capturing unit 110 on the basis of the vibration signal output by the vibration sensor 152 and information acquired from the overall control unit 8. A sensor similar to the vibration sensor 6 need only be used as the vibration sensor 152.

The drive unit 150 changes the position or the posture of the image capturing sensor 120 on the basis of an instruction (drive signal) from the image capturing control unit 130. By changing the position or the posture of the image capturing sensor 120, the image capturing unit 110 performs blur correction for reducing blur occurring in captured images due to vibration applied to the image capturing unit 110. For example, an actuator such as a stepper motor or a voice-coil motor is used as the drive unit 150.

The position sensor 151 detects the position or the posture of the image capturing sensor 120. The image capturing control unit 130 generates a drive signal for driving the image capturing sensor 120 in a direction, in which an influence of vibration of the image capturing unit 110 is reduced, on the basis of the vibration signal from the vibration sensor 152. The image capturing control unit 130 outputs a generated drive signal to the drive unit 150. The drive unit 150 performs blur correction by changing the position or the posture of the image capturing sensor 120 in a direction, in which an influence of vibration of the image capturing unit 110 is reduced, on the basis of the drive signal.

The lens barrel unit 200 is a lens device including an image capturing optical system. The lens barrel unit 200 has the image capturing optical system, drive units 231 to 233, position sensors 251 to 253, the lens barrel control unit 240, and a vibration sensor 254. The image capturing optical system includes a plurality of lenses, such as a zoom lens 210, a focus lens 220, and a stabilization lens 260, and an aperture. The image capturing optical system forms an optical image of a subject on the image capturing sensor 120.

At least a part or the entirety of the zoom lens 210 and the focus lens 220 is disposed movably along the optical axis. The magnification of an optical image reaching the image capturing sensor 120 is adjusted by the zoom lens 210. The focus position of an optical image reaching the image capturing sensor 120 is adjusted by the focus lens 220. The drive unit 231 moves at least a part or the entirety of the zoom lens 210 along the optical axis via mechanism members such as a cam ring and a guide shaft. Similarly, the drive unit 232 moves at least a part or the entirety of the focus lens 220 along the optical axis via the mechanism members such as the cam ring and the guide shaft. In response to a control instruction from the image capturing unit 110, the lens barrel control unit 240 performs at least one of a zoom operation and a focus operation by driving the drive unit 231 and the drive unit 232 to move the zoom lens 210 and the focus lens 220 in the optical axis direction. The position sensor 251 detects the position of the zoom lens 210. The position sensor 252 detects the position of the focus lens 220.

The lens barrel unit 200 has an optical image stabilizer (OIS) which corrects blur occurring in captured images by driving the stabilization lens 260. More specifically, the lens barrel unit 200 has the stabilization lens 260, the drive unit 233, the position sensor 253, and the vibration sensor 254 for blur correction, as the optical image stabilizer. In the present embodiment, the OIS corresponds to the second stabilization mechanism.

The vibration sensor 254 outputs a vibration signal (vibration value) corresponding to measured vibration in the image capturing unit 110 to the lens barrel control unit 240. The vibration sensor 254 (third sensor) is a device for measuring an angular velocity and an acceleration. For example, the vibration sensor 254 is an inertial measurement device. The lens barrel control unit 240 can acquire change in posture of the lens barrel unit 200 on the basis of the vibration signal output by the vibration sensor 254. A sensor similar to the vibration sensor 6 need only be used as the vibration sensor 254.

The stabilization lens 260 is a part of the lenses constituting the image capturing optical system for forming an optical image on the image capturing sensor 120. The stabilization lens 260 includes at least one lens and is disposed movably or rotatably in a direction orthogonal to the optical axis so as to reduce an influence of image blur caused by vibration. The drive unit 233 performs blur correction by changing the position or the posture of the stabilization lens 260. For example, an actuator such as a stepper motor or a voice-coil motor is used as the drive unit 233. The position sensor 253 detects the position or the posture of the stabilization lens 260.

The lens barrel control unit 240 generates a drive signal for driving the stabilization lens 260 in a direction, in which an influence of vibration of the lens barrel unit 200 is reduced, on the basis of the vibration signal from the vibration sensor 254. For example, the lens barrel control unit 240 is constituted of a microprocessor such as a CPU or an MPU. A program performed by the lens barrel control unit 240 may be stored in a memory (not shown) provided in the gimbal 2 or may be stored in a memory 9 provided in the mobile platform main body 3. The lens barrel control unit 240 outputs a generated drive signal to the drive unit 233. The drive unit 233 performs blur correction by changing the position or the posture of the stabilization lens 260 in a direction, in which an influence of vibration of the lens barrel unit 200 is reduced, on the basis of the drive signal. The lens barrel control unit 240 is connected to the image capturing control unit 130 of the image capturing unit 110 and controlled by an instruction of the image capturing control unit 130.

As described above, in the present embodiment, a drive amount with respect to a vibration signal can be individually adjusted for each vibration sensor by individually providing a vibration sensor in the image capturing unit 110 and the lens barrel unit 200. In the present embodiment, blur correction of the lens barrel unit 200 is performed on the basis of the vibration signal measured by the vibration sensor 254 provided in the lens barrel unit 200, but blur correction of the lens barrel unit 200 may be performed on the basis of the vibration signal measured by the vibration sensor 152 provided in the image capturing unit 110. In addition, conversely, blur correction of the image capturing unit 110 may be performed on the basis of the vibration signal measured by the vibration sensor 254 provided in the lens barrel unit 200. In this manner, the image capturing device 1 may include one vibration sensor and perform blur correction of the image capturing unit 110 and blur correction of the lens barrel unit 200 on the basis of measurement by the single vibration sensor. In addition, the image capturing device 1 need only have at least one of the OIS and the BIS as a mechanism for performing image blur correction.

The gimbal 2 controls a posture of the image capturing device 1. The gimbal 2 has a pitch axis mechanism 312, a roll axis mechanism 322, a yaw axis mechanism 332, drive units 311 to 331, a gimbal control unit 340, and a vibration sensor 350. The pitch axis mechanism 312 rotates the image capturing device 1 about a pitch axis. The pitch axis is an axis parallel to the X axis in FIG. 1A. That is, the pitch axis mechanism 312 is a first gimbal mechanism rotationally driven with a direction orthogonal to the optical axis direction of the image capturing device 1 as a first rotation axis. The roll axis mechanism 322 rotates the image capturing device 1 about a roll axis. The roll axis is an axis parallel to the Z axis and the optical axis of the image capturing device 1 in FIG. 1B. That is, the roll axis mechanism 322 is a second gimbal mechanism rotationally driven with a direction orthogonal to the first rotation axis as a second rotation axis. The yaw axis mechanism 332 rotates the image capturing device 1 about a yaw axis. The yaw axis is an axis parallel to the Y axis in FIG. 1C. That is, the yaw axis mechanism 332 is a third gimbal mechanism rotationally driven with a direction orthogonal to the first rotation axis and the second rotation axis as a third rotation axis.

The image capturing device 1 is rotatably attached to the pitch axis mechanism 312 of the gimbal 2. The pitch axis mechanism 312 supports the image capturing device 1. The roll axis mechanism 322 is rotatably connected to the pitch axis mechanism 312. The yaw axis mechanism 332 is rotatably connected to the roll axis mechanism 322. The drive unit 311 rotationally drives the pitch axis mechanism 312. The drive unit 321 rotationally drives the roll axis mechanism 322. The drive unit 331 rotationally drives the yaw axis mechanism 332. The pitch axis mechanism 312, the roll axis mechanism 322, and the yaw axis mechanism 332 are respectively driven and rotated by the drive unit 311, the drive unit 321, and the drive unit 331 to change the posture of the image capturing device 1. The gimbal control unit 340 outputs drive signals indicating drive amounts to the drive unit 311, the drive unit 321, and the drive unit 331, respectively.

The gimbal 2 performs blur correction reducing an influence of vibration of the image capturing device 1 by controlling the posture of the image capturing device 1. The vibration sensor 350 is disposed in the pitch axis mechanism 312, which is a mounting member for the image capturing device 1. The vibration sensor 350 outputs a vibration signal of the pitch axis mechanism 312 to the gimbal control unit 340. The vibration sensor 350 (second sensor) is a device for measuring an angular velocity and an acceleration of the gimbal 2. For example, the vibration sensor 350 is an inertial measurement device. The gimbal control unit 340 acquires change in posture of the image capturing device 1 on the basis of the vibration signal output by the vibration sensor 350. A sensor similar to the vibration sensor 6 need only be used as the vibration sensor 350.

The gimbal control unit 340 rotationally drives the respective mechanisms of the gimbal 2 in a direction, in which an influence of vibration of the image capturing device 1 is reduced, on the basis of the vibration signal from the vibration sensor 350. For example, the gimbal control unit 340 is constituted of a microprocessor such as a CPU or an MPU. The gimbal control unit 340 generates drive signals for rotationally driving the respective mechanisms of the gimbal 2 on the basis of the vibration signal from the vibration sensor 350. The gimbal control unit 340 generates and outputs drive signals for the drive unit 311, the drive unit 321, and the drive unit 331, respectively. The drive unit 311 controls the pitch axis mechanism 312 in a direction, in which an influence of vibration of the image capturing device 1 is reduced, on the basis of the drive signal. The drive unit 321 controls the roll axis mechanism 322 in a direction, in which an influence of vibration of the image capturing device 1 is reduced, on the basis of the drive signal. The drive unit 331 controls the yaw axis mechanism 332 in a direction, in which an influence of vibration of the image capturing device 1 is reduced, on the basis of the drive signal. The gimbal control unit 340 performs blur correction by respectively controlling the pitch axis mechanism 312 via the drive unit 311, the roll axis mechanism 322 via the drive unit 321, and the yaw axis mechanism 332 via the drive unit 331 in directions in which an influence of vibration of the image capturing device 1 is reduced.

The mobile platform main body 3 has the movement mechanism 5, the vibration sensor 6, the overall control unit 8, the memory 9, a mobile platform control unit 410, and a communication device 420. The mobile platform control unit 410 drives the movement mechanism 5 by issuing an instruction to the movement mechanism 5 to move the mobile platform image capturing device 100. The overall control unit 8 is connected to each of the image capturing control unit 130, the gimbal control unit 340, and the mobile platform control unit 410 and controls the entire mobile platform image capturing device 100 by issuing an instruction. For example, the overall control unit 8 issues a movement instruction for the mobile platform image capturing device 100 to the mobile platform control unit 410 on the basis of an operation instruction from the outside. For example, the mobile platform control unit 410 and the overall control unit 8 are each constituted of a microprocessor such as a CPU or an MPU.

The vibration sensor 6 measures an acceleration and an angular velocity of the mobile platform image capturing device 100. The overall control unit 8 calculates vibration (blur), the movement direction, and the movement speed of the mobile platform main body 3 on the basis of measurement results of the vibration sensor 6. For example, the overall control unit 8 can calculate the speed of the mobile platform image capturing device 100 using the acceleration measured by the vibration sensor 6. The image capturing control unit 130, the gimbal control unit 340, and the mobile platform control unit 410 acquire the vibration, the movement direction, and the movement speed of the mobile platform main body 3 calculated by the overall control unit 8 as the vibration, the movement direction, and the movement speed detected in the mobile platform main body 3. In addition, the overall control unit 8 may send a result of comparing at least one of the calculated vibration, movement direction, and movement speed with a threshold to the image capturing control unit 130, the gimbal control unit 340, and the mobile platform control unit 410 as a detection result in the mobile platform main body 3.

The memory 9 stores programs and the like necessary for the overall control unit 8 to control the image capturing device 1, the gimbal 2, and the mobile platform main body 3. The memory 9 need only be a computer-readable recording medium and may include at least one of an SRAM, a DRAM, an EPROM, an EEPROM, and a flash memory such as a USB memory. The communication device 420 is connected to the overall control unit 8 and communicates with the outside of the mobile platform image capturing device 100 to receive an operation instruction from the outside. A user can remotely operate the mobile platform image capturing device 100 from the outside via the communication device 420, the overall control unit 8, and the mobile platform control unit 410. The communication device 420 communicates with the outside of the mobile platform image capturing device 100 using communication means such as Wi-Fi or Bluetooth (registered trademark).

An example in which control realized by each control unit is realized by the CPU performing a computer program stored in the memory has been described, but a part or all of them may be realized by hardware. A dedicated circuit (ASIC), a processor (reconfigurable processor, DSP), or the like can be used as the hardware. In addition, for example, the functions realized by the hardware can also be realized by generating circuits on the basis of data read by a field programmable gate array (FPGA) from the memory. Alternatively, similarly to the FPGA, a method for forming a gate array circuit and realizing it as hardware, or a method for realizing it by an application specific integrated circuit (ASIC) may also be adopted.

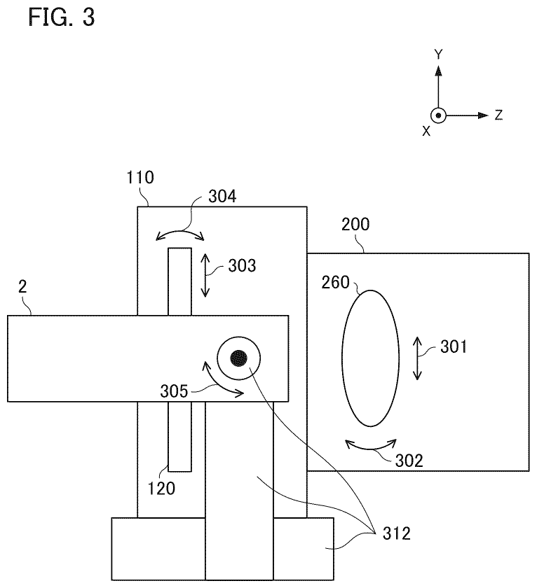

FIG. 3 is an explanatory view of a situation of blur correction of the mobile platform image capturing device 100 in a pitch direction. The mobile platform image capturing device 100 performs blur correction by driving at least one of the second stabilization unit provided in the image capturing device 1 and the first stabilization unit provided in the gimbal 2 on the basis of vibration signals from the vibration sensors respectively provided in the image capturing device 1 and the gimbal 2. The image capturing device 1 has the vibration sensor 152 in the image capturing unit 110 and the vibration sensor 254 in the lens barrel unit 200, and has the BIS in the image capturing unit 110 and the OIS in the lens barrel unit 200 as the second stabilization unit. The BIS performs blur correction by driving the image capturing sensor 120. The OIS performs blur correction by driving the stabilization lens 260. The gimbal 2 has the vibration sensor 350. In addition, the gimbal 2 controlling the posture of the image capturing device 1 functions as the first stabilization unit. The gimbal 2 performs blur correction by driving the pitch axis mechanism 312, the roll axis mechanism 322, and the yaw axis mechanism 332. The mobile platform image capturing device 100 of the present embodiment performs blur correction by driving at least one of the image capturing sensor 120, the stabilization lens 260, and the gimbal 2 on the basis of vibration signals from the vibration sensors provided in the image capturing unit 110, the lens barrel unit 200, and the gimbal 2, respectively.

An image capturing device 1 adopted in a mobile platform image capturing device 100 in the related art is an interchangeable-lens digital single-lens camera developed mainly for hand-held image capturing. Similarly, a gimbal 2 adopted in a mobile platform image capturing device 100 in the related art is a hand-held gimbal developed mainly for hand-held image capturing. Therefore, supported frequencies for blur correction of the image capturing device 1 and the gimbal 2 employed in the mobile platform image capturing device 100 in the related art are set to a low-frequency region of approximately 1 Hz to 10 Hz in accordance with camera shake vibration caused by a human hand during hand-held image capturing. In the present embodiment, in accordance with camera shake vibration caused by a human hand, a mode for correcting blur at a low frequency of approximately 10 Hz or lower will be referred to as a camera shake mode or the first stabilization mode.

On the other hand, vibration occurring in the image capturing device 1 when the mobile platform image capturing device 100 is traveling also includes high-frequency vibration of tens of Hz to hundreds of Hz caused by irregularities of a road surface or the movement mechanism. However, in blur correction of the mobile platform image capturing device 100 in the related art, a correction effect on a frequency band of tens of Hz to hundreds of Hz is smaller than a correction effect on a low-frequency region of approximately 1 Hz to 10 Hz. Therefore, even if blur correction in the related art targeted at camera shake (low-frequency camera shake) is performed when the mobile platform image capturing device 100 is traveling, high-frequency vibration remains as image blur so that high-quality video images cannot be captured. Since high-frequency image blur is highly likely to be visually conspicuous and is often uncomfortable to human eyes, it is also necessary to correct high-frequency image blur in order to capture high-quality video images in addition to low-frequency image blur.

Generally, it is easier to operate a lighter weight control target at a higher frequency than a heavier weight control target. Therefore, a lighter weight control target can correct higher-frequency image blur with higher accuracy than a heavier weight control target. In blur correction by the image capturing unit 110, the lens barrel unit 200, and the gimbal 2 of the mobile platform image capturing device 100, since weights of control targets of the image capturing sensor 120, the stabilization lens 260, and the gimbal 2 are different, ease of movement is also different. Generally, weights of control targets for blur correction increase in order of the stabilization lens 260 of the lens barrel unit 200, the image capturing sensor 120 of the image capturing unit 110, and the rotational drive mechanisms of the gimbal 2. Depending on the constitution of the image capturing device 1, the image capturing sensor 120 may be lighter than the stabilization lens 260, and therefore the order of the lens barrel unit 200 and the image capturing unit 110 may be reversed. Since the gimbal 2 operates in a state of holding the image capturing device 1, the stabilization unit (first stabilization unit) of the gimbal 2 is heavier in weight than the two units of the stabilization unit (second stabilization unit) of the image capturing device 1.

It is easier to operate a lighter weight control target at a higher frequency than a heavier weight control target, and therefore a lighter weight control target can correct higher-frequency image blur with higher accuracy than a heavier weight control target. In other words, ease of correcting high-frequency image blur is in the order of the second stabilization unit (the stabilization unit of the lens barrel unit 200 and the stabilization unit of the image capturing unit 110) and the first stabilization unit (the stabilization unit of the gimbal 2). Utilizing the characteristics, in the present embodiment, more advanced blur correction is realized by sharing supported frequency bands for blur correction of the image capturing device 1 (the lens barrel unit 200 and the image capturing unit 110) and the gimbal 2 while taking ease of movement into consideration. Therefore, the second stabilization unit of the image capturing device 1 performs blur correction so as to cancel vibration in a high-frequency band, and the first stabilization unit of the gimbal 2 performs blur correction so as to cancel vibration in a low-frequency band.

The image capturing device 1 of the present embodiment has two blur correction modes (correction modes) and performs control of switching the blur correction mode between when used in the mobile platform image capturing device 100 and when used without being mounted on the mobile platform image capturing device 100, such as in hand-held image capturing. When used without being mounted on the mobile platform image capturing device 100 such as in hand-held image capturing, the image capturing device 1 corrects blur in a first frequency band (low frequency) in the first stabilization mode (camera shake mode). When used in the mobile platform image capturing device 100, the image capturing device 1 corrects blur in a second frequency band (high frequency) which is higher in frequency than the first frequency band in the second stabilization mode (mobile platform mode). That is, the second stabilization mode is targeted for blur correction at a frequency band higher than a frequency band targeted for blur correction by the first stabilization mode. In this manner, when used in the mobile platform image capturing device 100, control of blur correction of the image capturing device 1 is changed and the supported frequency is assigned to a higher-frequency side.

In addition, in the first stabilization mode (camera shake mode), frequencies supported by the two units of the stabilization unit of the image capturing device 1 may be made different. Specifically, regarding high frequencies, the lightest OIS of the lens barrel unit 200 is assigned to the highest-frequency side, and the BIS of the image capturing unit 110, which is the next lightest after the OIS, is assigned to a frequency between the supported frequencies of the OIS and the gimbal 2. Accordingly, blur correction on the highest-frequency side is assigned to the lens barrel unit 200, blur correction in an intermediate frequency is assigned to the image capturing unit 110, and blur correction on the lowest-frequency side corresponding to a camera shake frequency is assigned to the gimbal 2. The image capturing unit 110, the lens barrel unit 200, and the gimbal 2 each perform blur correction so as to cancel vibration in the assigned frequency band. If the weights of the OIS and the BIS are reversed, frequency bands assigned to the image capturing unit 110 and the lens barrel unit 200 may be interchanged.

FIG. 3 is a view of a part of the image capturing device 1 and the gimbal 2 viewed in the lateral direction (positive X axis direction). Arrows 301 and 302 indicate examples of drive directions of the stabilization lens 260. Arrows 303 and 304 indicate examples of drive directions of the image capturing sensor 120. An arrow 305 indicates a drive direction of the pitch axis mechanism 312 provided in the gimbal 2. The arrow 301 indicates shift drive of the stabilization lens 260 in a plane parallel to an XY plane, and the arrow 303 indicates shift drive of the image capturing sensor 120 in a plane parallel to the XY plane. The arrows 302, 304, and 305 respectively indicate rotation in the pitch direction of the stabilization lens 260, the image capturing sensor 120, and the pitch axis mechanism 312. In the mobile platform image capturing device 100, in order to correct blur in the pitch direction, each of the three units of stabilization unit of the stabilization lens 260, the image capturing sensor 120, and the pitch axis mechanism 312 is driven and controlled so as to cancel vibration in an assigned frequency band. In addition, regarding blur in a roll direction and a yaw direction as well, similarly to blur in the pitch direction, correction is performed by driving each of the stabilization lens 260, the image capturing sensor 120, and the gimbal 2 so as to cancel vibration in the assigned frequency band. The stabilization lens 260 may correct blur in the pitch direction by performing shift drive in the direction of the arrow 301 without performing rotation in the pitch direction as indicated by the arrow 302. In addition, the image capturing sensor 120 may correct blur in the pitch direction by performing shift drive in the direction of the arrow 303 without performing rotation in the pitch direction as indicated by the arrow 304. In addition, since rotation of the stabilization lens 260 in the roll direction does not provide a correction effect against blur in the roll direction, a constitution in which the stabilization lens 260 does not rotate in the roll direction may be adopted. As described above, the image capturing sensor 120 may be constituted not to be able to rotate in the pitch direction and the yaw direction, and the stabilization lens 260 may be constituted not to rotate in the pitch direction, the yaw direction, and the roll direction.

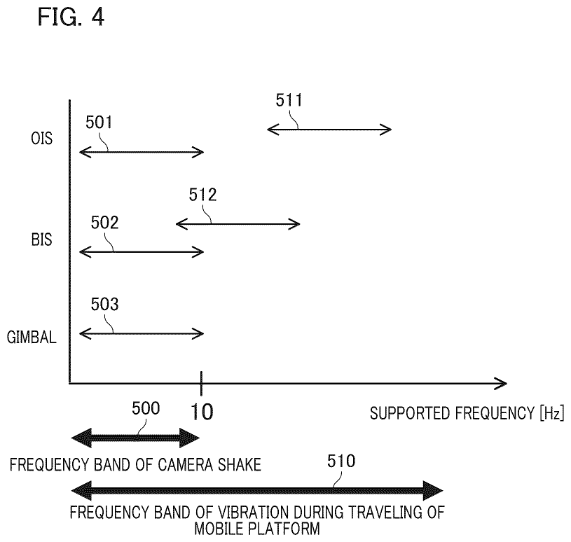

FIG. 4 is an explanatory view of frequency bands targeted for blur correction for each correction mode. FIG. 4 shows change in relationship between the frequency bands for blur correction assigned to each of the OIS of the lens barrel unit 200, the BIS of the image capturing unit 110, and the gimbal 2 in the first stabilization mode (camera shake mode) and the second stabilization mode (mobile platform mode). The first stabilization mode (camera shake mode) is a mode in which the image capturing device 1 is used alone without being mounted on the mobile platform image capturing device 100. The second stabilization mode (mobile platform mode) is a mode in which the image capturing device 1 is used while being mounted on the mobile platform image capturing device 100.

In FIG. 4, the horizontal axis indicates supported frequencies for blur correction. A frequency band 500 indicates a frequency band of image blur occurring in an image by camera shake and is a low-frequency band of approximately 10 Hz or lower. A frequency band 510 indicates a frequency band of image blur occurring in an image during traveling of the mobile platform and includes a high-frequency band of 10 Hz or higher including the frequency band 500. A frequency band 501 indicates the supported frequency band of the OIS of the lens barrel unit 200 when the image capturing device 1 is used alone, and a frequency band 511 indicates the supported frequency band of the OIS of the lens barrel unit 200 when mounted on the mobile platform image capturing device 100. A frequency band 502 indicates the supported frequency band of the BIS of the image capturing unit 110 when the image capturing device 1 is used alone, and a frequency band 512 indicates the supported frequency band of the BIS of the image capturing unit 110 when mounted on the mobile platform image capturing device 100. A frequency band 503 indicates the supported frequency band for blur correction of the gimbal 2. The frequency bands 501, 502, and 503 correspond to the frequency band 500. A combination of the frequency bands 503, 511, and 512 corresponds to the frequency band 510. The frequency band 511 is on the highest-frequency side in the frequency band 510, the frequency band 503 is on the lowest-frequency side in the frequency band 510, and the frequency band 512 is between the frequency band 511 and the frequency band 503. The low-frequency side of the frequency band 512 overlaps the high-frequency side of the frequency band 503, and the high-frequency side of the frequency band 512 overlaps the low-frequency side of the frequency band 511. The frequency bands for blur correction respectively assigned to the OIS of the lens barrel unit 200, the BIS of the image capturing unit 110, and the gimbal 2 may have several variations depending on a situation of the mobile platform image capturing device 100.

When the image capturing device 1 is used alone, that is, in the first stabilization mode, the frequency bands for blur correction of the lens barrel unit 200, the image capturing unit 110, and the gimbal 2 are set in a low-frequency region of approximately 1 Hz to 10 Hz in accordance with camera shake vibration caused by a human hand. In the second stabilization mode, the frequency bands for blur correction of the lens barrel unit 200, the image capturing unit 110, and the gimbal 2 are respectively set to different frequency bands so that they can cope with a wide frequency band including high-frequency vibration occurring when the mobile platform image capturing device 100 is traveling. Specifically, in the second stabilization mode, the OIS of the lens barrel unit 200 is controlled to be targeted at the frequency band 511, the BIS of the image capturing unit 110 is controlled to be targeted at the frequency band 512, and the gimbal 2 is controlled to be targeted at the frequency band 503 for blur correction.

The gimbal 2 is set to be targeted for correction at the same frequency band 503 regardless of whether the image capturing device 1 is in the first stabilization mode or the second stabilization mode. That is, the frequency band targeted for blur correction by the first stabilization unit of the gimbal 2 is always set to a low-frequency region of approximately 1 Hz to 10 Hz.

The BIS of the image capturing unit 110 is set to be targeted at the frequency band 502 in the first stabilization mode and to be targeted at the frequency band 512 in the second stabilization mode. The OIS of the lens barrel unit 200 is set to be targeted at the frequency band 501 in the first stabilization mode and to be targeted at the frequency band 511 in the second stabilization mode. In this manner, in the second stabilization mode, the BIS (first stabilization mechanism) and the OIS (second stabilization mechanism) are targeted for blur correction at different frequency bands. In addition, in the second stabilization mode, the second stabilization unit of the image capturing device 1 is targeted for blur correction at frequency bands 511 and 512, which are higher than the frequency band 500. That is, the second stabilization unit of the image capturing device 1 is targeted for blur correction at a low-frequency region of approximately 1 Hz to 10 Hz in the first stabilization mode, and is targeted for blur correction at a frequency band higher than that in the first stabilization mode in the second stabilization mode. In this manner, in the second stabilization mode, it is possible to cope with a wide frequency band including high-frequency vibration occurring when the mobile platform image capturing device 100 is traveling by performing blur correction centered on different frequency bands for the lens barrel unit 200, the image capturing unit 110, and the gimbal 2.

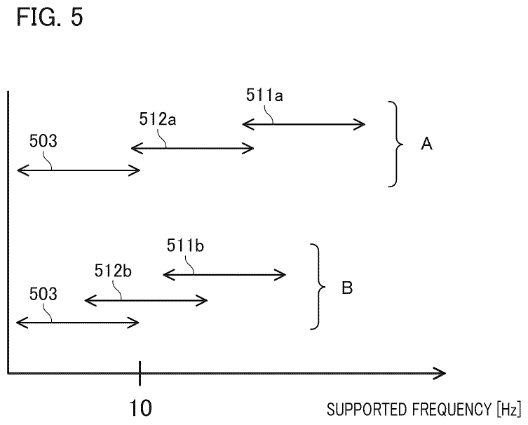

In the second stabilization mode, the frequency bands for blur correction respectively assigned to the OIS of the lens barrel unit 200, the BIS of the image capturing unit 110, and the gimbal 2 may have several variations depending on a situation of the mobile platform image capturing device 100. FIG. 5 is an explanatory view of variations in assignment of frequency bands in the second stabilization mode. Here, two variations, such as a variation A and a variation B, will be described as an example, but the variation of frequency band to be assigned is not limited thereto, and a constitution having a plurality of variations may be adopted.

The variation A is an assignment of frequencies in which the entirety is shifted to a higher-frequency band and can cope with higher-frequency vibration. Hereinafter, control of blur correction corresponding to the variation A will be defined as a first mobile platform mode. The variation B cannot cope with vibration of as high a frequency as the variation A, but it is possible to cope with vibration of larger amplitude by providing many overlapping regions of the supported frequencies for blur correction. Hereinafter, control of blur correction corresponding to the variation B will be defined as a second mobile platform mode.

In FIG. 5, the horizontal axis indicates supported frequencies for blur correction. A frequency band 511a indicates the supported frequency band of the OIS of the lens barrel unit 200 in the variation A. A frequency band 512a indicates the supported frequency band of the BIS of the image capturing unit 110 in the variation A. A frequency band 511b indicates the supported frequency band of the OIS of the lens barrel unit 200 in the variation B. A frequency band 512b indicates the supported frequency band of the BIS of the image capturing unit 110 in the variation B. The frequency band 503 indicates the supported frequency band of the gimbal 2 in the variation A and the variation B.

Here, vibration occurring when the mobile platform image capturing device 100 is traveling in the present embodiment will be described. First, a relationship between a speed and vibration when the mobile platform image capturing device 100 is traveling will be described. When the mobile platform image capturing device 100 is traveling, vibration mainly occurs due to irregularities of a road surface or the movement mechanism. Therefore, the higher the movement speed during traveling, the more the number of times of contact with the irregularities per unit time increases, and therefore higher-frequency vibration tends to occur. In order to reduce an influence of high-frequency vibration caused by high-speed movement, it is preferable to perform control such that blur correction is performed in the first mobile platform mode (variation A), which is targeted for blur correction at a higher frequency band, when the movement speed of the mobile platform main body 3 is higher than a threshold.

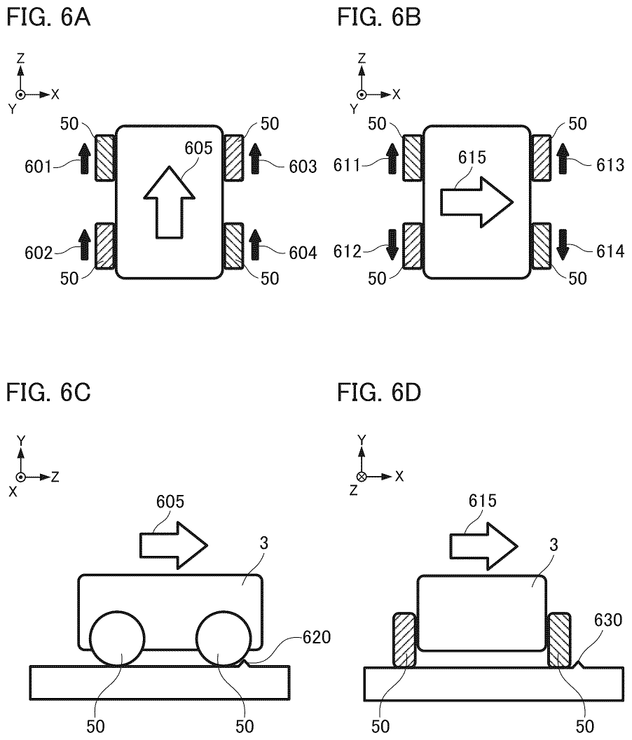

Next, a relationship between a movement direction and vibration when the mobile platform image capturing device 100 is traveling will be described. In the present embodiment, a Mecanum wheel mechanism for rotatably holding a plurality of rollers around wheels is used as the movement mechanism 5 of the mobile platform main body 3, and a constitution capable of moving in all directions is adopted. FIGS. 6A to 6D are explanatory views of a relationship between the movement direction and vibration of the mobile platform main body 3 (mobile platform). FIGS. 6A and 6B are views showing rotation directions of the respective wheels 50 and the movement direction of the mobile platform main body 3.

FIGS. 6A and 6B are top views (positive Y axis direction) of the mobile platform main body 3. In FIGS. 6A and 6B, orientations of the plurality of rollers attached to the Mecanum wheel mechanism in the circumferential direction are simply indicated by straight lines. In FIG. 6A, arrows 601 to 604 indicate the rotation directions of the respective wheels 50. When all the wheels 50 are rotated in the same direction, the mobile platform main body 3 travels in a direction in which the wheels 50 rotate (front-rear direction). In the example shown in FIG. 6A, all the wheels 50 are rotated in directions indicated by the arrows 601 to 604, and the mobile platform main body 3 travels in a direction of the arrow 605, which is the direction in which the wheels 50 rotate.

In FIG. 6B, arrows 611 to 614 indicate rotation directions of the respective wheels 50. When front and rear wheels 50 are rotated in opposite directions, the mobile platform main body 3 travels in a direction orthogonal to the direction in which the wheels 50 rotate (lateral direction). In the example shown in FIG. 6B, two wheels 50 in the positive Z axis direction are rotated in the positive Z axis direction as indicated by the arrows 611 and 613, and two wheels 50 in the negative Z axis direction are rotated in the negative Z axis direction as indicated by the arrows 612 and 614. Therefore, the mobile platform main body 3 travels in a direction of an arrow 615 (positive X axis direction), which is a direction orthogonal to the direction in which the wheels 50 rotate. In this manner, the mobile platform main body 3 realizes translational movement and rotational movement in all directions by controlling a combination of rotation directions and a proportion of rotation speeds of the respective wheels 50.

As shown in FIG. 6A, regarding the movement direction of the mobile platform main body 3, when a component in the axial direction (X axis direction) of the wheels 50 is smaller than a component in a direction perpendicular to the axial direction (Z axis direction), it is determined that the proportion of forward, backward, leftward, and rightward movement in the movement direction of the mobile platform main body 3 is larger in the front-rear direction than in the lateral direction. As shown in FIG. 6B, when a component in the axial direction (X axis direction) of the wheels 50 is larger than a component in a direction perpendicular to the axial direction (Z axis direction), it is determined that the proportion of forward, backward, leftward, and rightward movement in the movement direction of the mobile platform main body 3 is larger in the lateral direction than in the front-rear direction.

Here, vibration received due to irregularities of a road surface for each traveling direction of the mobile platform main body 3 will be described. FIGS. 6C and 6D are views showing a situation in which the mobile platform main body 3 rides over a protrusion on a path of the mobile platform main body 3. FIG. 6C shows a situation in which the mobile platform main body 3 is traveling forward in the direction of an arrow 605. There is a protrusion 620 on the road surface ahead in the traveling direction of the mobile platform main body 3. When the mobile platform main body 3 rides over the protrusion 620 while traveling forward, the plurality of rollers continuously come into contact with the protrusion 620. Since all the wheels 50 having a large curvature ride over the protrusion 620, the frequency of vibration occurring in the mobile platform main body 3 when riding over is low.

FIG. 6D shows a situation in which the mobile platform main body 3 is traveling in the direction of the arrow 615 (right direction). There is a protrusion 630 on the road surface ahead in the traveling direction of the mobile platform main body 3. The protrusion 630 is a protrusion having the same shape as the protrusion 620. When the mobile platform main body 3 rides over the protrusion 630 while traveling in the right direction, a single roller having a small curvature comes into contact with the protrusion 630. Since a single roller having a small curvature rides over the protrusion 630, the frequency of vibration occurring in the mobile platform main body 3 when riding over is high. In this manner, a difference occurs in the frequency of vibration when riding over a protrusion on the road surface depending on the movement direction of the mobile platform main body 3. That is, the frequency of vibration tends to be lower during traveling in the front-rear direction of the mobile platform main body 3 and to be higher during traveling in the lateral direction. In order to reduce an influence of high-frequency vibration depending on the movement direction, when the proportion of a component in the lateral direction in the movement direction of the mobile platform main body 3 is higher than that in the front-rear direction, it is preferable to perform control such that blur correction is performed in the first mobile platform mode, which is targeted for blur correction at a higher frequency band.

Accordingly, in the present embodiment, the assignment of supported frequencies for blur correction when the image capturing device 1 is mounted on the mobile platform image capturing device 100 is changed in accordance with the situation of the mobile platform image capturing device 100. When the speed of the mobile platform main body 3 is high, in which higher-frequency vibration is likely to occur, or when the proportion in the lateral direction is high in the movement direction of the mobile platform main body 3, an assignment of the first mobile platform mode (variation A in FIG. 5) is used. Conversely, when the speed of the mobile platform main body 3 is low, in which lower-frequency vibration is likely to occur, or when the proportion in the front-rear direction is high in the movement direction of the mobile platform main body 3, an assignment of the second mobile platform mode (variation B in FIG. 5) is used. In this manner, appropriate blur correction can be realized in the mobile platform image capturing device 100 in accordance with a wider range of situations by changing the assignment of supported frequencies for blur correction in accordance with at least one of the movement speed and the movement direction of the mobile platform image capturing device 100.

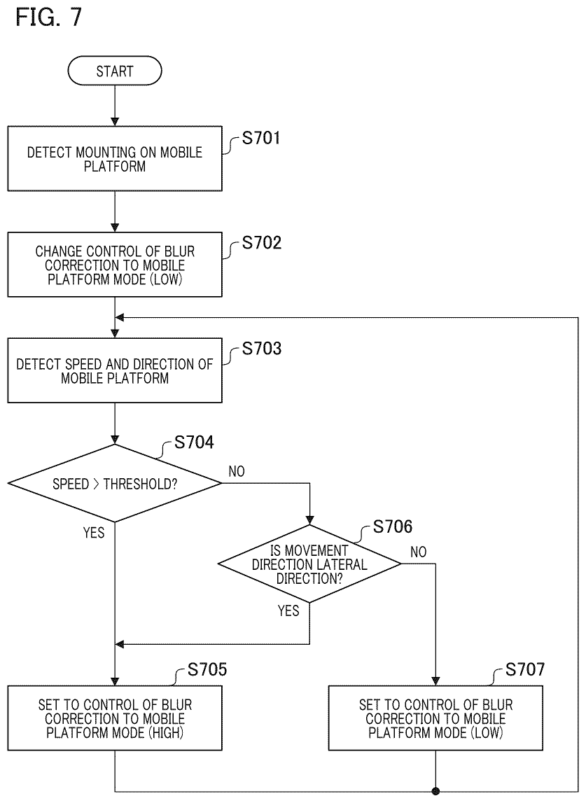

Change in control of blur correction of the image capturing device 1 of the present embodiment will be described with reference to FIG. 7. FIG. 7 is a flowchart showing control processing for blur correction in the image capturing device 1. The processing shown in the flowchart of FIG. 7 starts, for example, when the image capturing device 1 is mounted on the mobile platform image capturing device 100, the image capturing control unit 130 of the image capturing device 1 and the overall control unit 8 of the mobile platform main body 3 are connected and start communication therebetween. However, a user may judge by himself/herself and change settings of blur correction of the image capturing device 1.

In S701, the image capturing control unit 130 of the image capturing device 1 communicates with the overall control unit 8 of the mobile platform main body 3 and detects that the image capturing device 1 has been mounted on the mobile platform main body 3 via the gimbal 2. A method for detecting that it has been mounted may be a known method such as a mechanical switch or a magnetic switch. If the image capturing device 1 detects that it has been mounted on the mobile platform, processing of S702 is performed. In S702, the image capturing control unit 130 changes control of blur correction of the image capturing device 1 to the second mobile platform mode of the second stabilization mode. More specifically, the image capturing control unit 130 changes control of blur correction of the image capturing device 1 from the first stabilization mode (camera shake mode) to the second mobile platform mode (variation B) of the second stabilization mode (mobile platform mode). The second mobile platform mode is a mode assumed for a case where the speed of the mobile platform main body 3 moving the image capturing device 1 is not high (lower than a threshold) and the proportion in the front-rear direction is higher in the movement direction of the mobile platform main body 3. In this manner, if the image capturing control unit 130 detects that the image capturing device 1 has been mounted on the mobile platform, the image capturing control unit 130 controls the stabilization unit (second stabilization unit) of the image capturing device 1 to be the second stabilization mode from the first stabilization mode.

In S703, the overall control unit 8 of the mobile platform main body 3 detects the movement speed and the movement direction of the mobile platform main body 3 of the mobile platform image capturing device 100. The overall control unit 8 detects the movement speed and the movement direction of the mobile platform main body 3 on the basis of measurement results by the vibration sensor 6 provided in the mobile platform main body 3. The overall control unit 8 of the mobile platform main body 3 sends a detection result to the image capturing control unit 130 of the image capturing device 1. Further, the image capturing control unit 130 switches between the first mobile platform mode and the second mobile platform mode and performs control of blur correction of the image capturing device 1 in accordance with the detected movement speed and movement direction of the mobile platform main body 3. First, in S704, the image capturing control unit 130 determines whether the movement speed of the mobile platform main body 3 detected in S703 is higher than the threshold. If it is determined that the movement speed is higher than the threshold, the image capturing control unit 130 performs processing of S705. If it is determined that the movement speed is equal to or lower than the threshold, the image capturing control unit 130 performs processing of S706.

In S706, the image capturing control unit 130 determines whether the proportion in the lateral direction is higher than the proportion in the front-rear direction regarding the movement direction of the mobile platform main body 3 detected in S703. If it is determined that the proportion in the lateral direction is higher, the image capturing control unit 130 performs processing of S705. If it is determined that the proportion in the front-rear direction is higher, the image capturing control unit 130 performs processing of S707. When the proportion in the front-rear direction and the proportion in the lateral direction are the same, the image capturing control unit 130 performs processing of S707 but may perform processing of S705. In addition, in the present embodiment, the presence or absence of switching of the mobile platform mode is determined by comparing the proportion in the lateral direction and the proportion in the front-rear direction, but it is not limited thereto. For example, the processing of S705 may be performed when the proportion in the lateral direction exceeds a predetermined proportion.

In S705, the image capturing control unit 130 performs control of setting blur correction of the image capturing device 1 to the first mobile platform mode. The first mobile platform mode is a mode assumed for a case where the speed of the mobile platform main body 3 moving the image capturing device 1 is high or a case where the proportion in the lateral direction is high in the movement direction of the mobile platform main body 3. In this manner, when the speed detected in S703 is equal to or higher than the threshold or when the proportion in the lateral direction detected in S703 is higher in the movement direction, the image capturing control unit 130 controls blur correction of the image capturing device 1 in the first mobile platform mode.

In S707, the image capturing control unit 130 performs control to set blur correction of the image capturing device 1 to the second mobile platform mode. In this manner, when the speed detected in S703 is lower than the threshold and when the proportion in the lateral direction detected in S703 is lower in the movement direction, the image capturing control unit 130 controls blur correction of the image capturing device 1 in the second mobile platform mode. After S705 and S707, processing returns to S703. In the present embodiment, an example in which the processing of S704 and S706 is performed by the image capturing control unit 130 has been described, but it is not limited thereto. The processing of S704 and S706 may be performed by the overall control unit 8, and the overall control unit 8 may instruct the image capturing control unit 130 of a determination result or may issue an instruction to change the stabilization mode corresponding to the determination result.

In addition, in the present embodiment, determination regarding the speed (S704) is performed prior to determination regarding the movement direction (S705), but the order of determination may be reversed. When the situation corresponds to at least one of a case where the speed of the mobile platform main body 3 is equal to or higher than the threshold and a case where the proportion in the lateral direction is higher in the movement direction of the mobile platform main body 3, blur correction of the image capturing device 1 mounted on the mobile platform image capturing device 100 is set to the first mobile platform mode of the second stabilization mode. When the situation corresponds to neither of the case where the speed of the mobile platform main body 3 is equal to or higher than the threshold and the case where the proportion in the lateral direction is higher in the movement direction of the mobile platform main body 3, blur correction of the image capturing device 1 mounted on the mobile platform image capturing device 100 is set to the second mobile platform mode of the second stabilization mode. Further, when the image capturing device is not mounted on the mobile platform image capturing device 100, blur correction of the image capturing device 1 is set to the first stabilization mode. Furthermore, control may be simplified and processing after S703 may be omitted. In addition, instead of detecting in S701 that the image capturing device 1 has been mounted on the mobile platform main body 3 via the gimbal 2, processing may proceed to S702 in response to detection of vibration in a predetermined high-frequency band by at least one of the vibration sensor 152 and the vibration sensor 254.

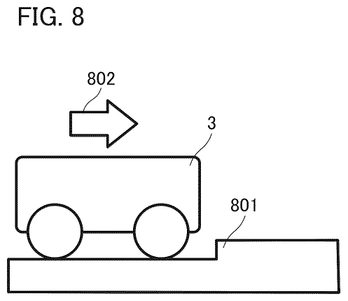

In the foregoing description, it has been described on the assumption that a protrusion on a path of the mobile platform main body 3 causing vibration of the image capturing device 1 is relatively small with respect to diameters of the wheels 50 and that high-frequency vibration occurs when riding over a protrusion. Here, vibration occurring when the mobile platform image capturing device 100 rides over a large step will be described. FIG. 8 is a view showing a large step on a path of the mobile platform main body 3. A step 801 is larger than the protrusion 620 in FIG. 6C, and when the mobile platform main body 3 rides over it, a large impact (vibration of a predetermined magnitude or greater) instantaneously occurs in the mobile platform image capturing device 100. The impact occurring when the mobile platform main body 3 rides over the step 801 is propagated to the image capturing device 1 as large vibration including various frequencies.

If control of blur correction of the image capturing device 1 is set to the mobile platform mode driven at high frequency when the mobile platform main body 3 rides over the step 801, there is a probability that the impact caused by riding over the step 801 may make the stabilization lens 260 of the OIS or the image capturing sensor 120 of the BIS likely to oscillate. If the stabilization lens 260 of the OIS or the image capturing sensor 120 of the BIS oscillates, control from the image capturing device 1 becomes impossible, and there is a probability that abnormal noise may occur and excess current or heat may be generated, causing damage to each of the drive units.

Accordingly, in the present embodiment, when a large impact is detected by the vibration sensor 6 of the mobile platform main body 3 when the mobile platform image capturing device 100 is traveling, control of switching blur corrections of the two parts in the image capturing device 1 from the mobile platform mode to the camera shake mode is performed and the processing waits until the impact settles. Consequently, oscillation of blur corrections of the two parts in the image capturing device 1 can be restrained and the functions of the OIS and the BIS can be prevented from being impaired. In the present embodiment, the overall control unit 8 determines that a large impact (vibration of a predetermined magnitude or greater) has been detected when the vibration sensor 6 measures an acceleration equal to or higher than a threshold. Detection of such a large impact (vibration of a predetermined magnitude or greater) of the mobile platform main body 3 is not limited thereto. There is a probability that such a large impact may occur similarly not only when the mobile platform main body 3 rides over a large step but also when the mobile platform main body 3 suddenly stops or suddenly decelerates during high-speed movement and when the mobile platform main body 3 suddenly starts from a stop state or suddenly accelerates. Therefore, similar handling may also be adopted in such situations.

As described above, when the image capturing device 1 is not mounted on the mobile platform, the image capturing device 1 of the present embodiment controls the stabilization unit of the image capturing device 1 in the first stabilization mode, which is a camera shake correction mode. On the other hand, when the image capturing device 1 is mounted on the mobile platform, the image capturing device 1 controls the stabilization unit of the image capturing device 1 in the second stabilization mode, which is targeted for blur correction at a frequency band higher than a frequency band targeted for blur correction by the first stabilization mode. In addition, even in the case where the image capturing device 1 is mounted on the mobile platform, when a large impact (vibration of a predetermined magnitude or greater) is detected in the mobile platform, the stabilization unit of the image capturing device 1 is controlled to be the first stabilization mode from the second stabilization mode. In this manner, the image capturing device 1 controls the stabilization unit of the image capturing device 1 to be the first stabilization mode or the second stabilization mode in accordance with the presence or absence of the image capturing device 1 being mounted on the gimbal 2 (mobile platform) and vibration detected in the mobile platform.

According to the present embodiment, it is possible to control a frequency band targeted for blur correction in accordance with a state such as whether the image capturing device is mounted on the mobile platform. Accordingly, it is possible to reduce blur occurring in images captured in a state where the image capturing device is mounted on the mobile platform. In the present embodiment, a constitution in which the mobile platform travels on the ground has been described, but at least a part of the control described in the present embodiment can also be applied to a constitution in which the mobile platform flies in the air. For example, in the case of a drone in which a camera is detachably attached to a gimbal portion and has a constitution in which a plurality of propellers are rotated for hovering and movement, there is a probability that high-frequency vibration may be transmitted to the image capturing device mounted on the drone because the propellers rotate at a high speed. Therefore, the stabilization mode may be changed as in the present embodiment between when the image capturing device is mounted on a drone (mobile platform) having a plurality of propellers and when it is not mounted thereon.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and performing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-224213, filed Dec. 19, 2024, which is hereby incorporated by reference wherein in its entirety.

What is claimed is:

1. An image capturing device which is mountable on a mobile platform having first stabilization unit, the device comprising:
second stabilization unit configured to perform blur correction by driving a stabilization member; and
at least one processor and memory holding a program which makes the processor function as a controller configured to control the second stabilization unit using a first stabilization mode or a second stabilization mode which is targeted for blur correction at a frequency band higher than a frequency band targeted for blur correction by the first stabilization mode,
wherein the controller controls the second stabilization unit to be the first stabilization mode or the second stabilization mode in accordance with at least one of the presence or absence of the image capturing device being mounted on the mobile platform and detected vibration.

2. The image capturing device according to claim 1,
wherein when it is detected that the image capturing device is mounted on the mobile platform, the controller controls the second stabilization unit to be the second stabilization mode.

3. The image capturing device according to claim 1,
wherein when the image capturing device is mounted on the mobile platform and vibration of a predetermined magnitude or greater is detected in the mobile platform, the controller controls the second stabilization unit to be the first stabilization mode.

4. The image capturing device according to claim 1,
wherein the frequency band targeted for blur correction by the second stabilization unit in the second stabilization mode is higher than the frequency band targeted for blur correction by the first stabilization unit.

5. The image capturing device according to claim 1,
wherein the frequency band targeted for blur correction by the second stabilization unit in the first stabilization mode is a frequency band of approximately 1 Hz to 10 Hz.

6. The image capturing device according to claim 1,
wherein the second stabilization unit has at least one of a first stabilization mechanism for performing blur correction by driving an image capturing sensor, and a second stabilization mechanism for performing blur correction by driving a part of lenses constituting an image capturing optical system for forming an optical image on the image capturing sensor.

7. The image capturing device according to claim 6,
wherein when the second stabilization unit has the first stabilization mechanism and the second stabilization mechanism, the first stabilization mechanism and the second stabilization mechanism are targeted for blur correction at different frequency bands in the second stabilization mode, and
the controller controls the frequency bands targeted for blur correction respectively by the first stabilization mechanism and the second stabilization mechanism in accordance with at least one of a movement speed and a movement direction of the mobile platform acquired from the mobile platform.

8. The image capturing device according to claim 7,
wherein the controller controls the frequency bands targeted for blur correction respectively by the first stabilization mechanism and the second stabilization mechanism to be higher frequency bands when the movement speed of the mobile platform is higher than a threshold or when a proportion in a lateral direction is higher than a proportion in a front-rear direction in the movement direction of the mobile platform, than when the movement speed of the mobile platform is equal to or lower than the threshold and a component in the front-rear direction is larger than a component in the lateral direction in the movement direction of the mobile platform.

9. A mobile platform image capturing device which has an image capturing device and a mobile platform for mounting the image capturing device, and is capable of capturing images while moving, the mobile platform image capturing device comprising:
the image capturing device comprising:
second stabilization unit configured to perform blur correction by driving a stabilization member, and
at least one processor and memory holding a program which makes the processor function as a controller configured to control the second stabilization unit using a first stabilization mode or a second stabilization mode which is targeted for blur correction at a frequency band higher than a frequency band targeted for blur correction by the first stabilization mode, and
the mobile platform comprising:
first stabilization unit configured to perform blur correction by controlling a posture of the image capturing device,
a first sensor configured to measure an acceleration and an angular velocity of the mobile platform, and
an overall controller configured to calculate a movement direction, a movement speed, and vibration of the mobile platform on the basis of measurement results of the first sensor,
wherein the controller controls the second stabilization unit to be the first stabilization mode or the second stabilization mode in accordance with at least one of the presence or absence of the image capturing device being mounted on the mobile platform and detected vibration.

10. The mobile platform image capturing device according to claim 9,
wherein the mobile platform further has a Mecanum wheel mechanism configured to rotatably hold a plurality of rollers around wheels and be capable of moving in all directions, and
when a component in an axial direction of the wheels of the Mecanum wheel mechanism is larger than a component perpendicular to the axial direction in the movement direction of the mobile platform, it is determined that a lateral component is larger in the movement direction of the mobile platform.

11. The mobile platform image capturing device according to claim 9,
wherein the mobile platform has a plurality of propellers.

12. The mobile platform image capturing device according to claim 9,
wherein the mobile platform further has a gimbal configured to include a first gimbal mechanism supporting the image capturing device and rotationally driven with a direction orthogonal to an optical axis direction of the image capturing device as a first rotation axis, a second gimbal mechanism rotationally driven with a direction orthogonal to the first rotation axis as a second rotation axis, and a third gimbal mechanism rotationally driven with a direction orthogonal to the first rotation axis and the second rotation axis as a third rotation axis, and a second sensor configured to measure an acceleration and an angular velocity of the gimbal,
in the mobile platform, a posture of the image capturing device supported by the first gimbal mechanism is controlled by rotationally driving the first to third gimbal mechanisms on the basis of measurement results of the second sensor,
the image capturing device has a third sensor configured to measure an acceleration and an angular velocity of the image capturing device, and
the controller controls driving of the stabilization member by the second stabilization unit on the basis of measurement results of the third sensor.

13. The mobile platform image capturing device according to claim 9,
wherein the frequency band targeted for blur correction by the second stabilization unit in the second stabilization mode is higher than the frequency band targeted for blur correction by the first stabilization unit.

14. The mobile platform image capturing device according to claim 9,
wherein the frequency band targeted for blur correction by the second stabilization unit in the first stabilization mode is a frequency band of approximately 1 Hz to 10 Hz.

15. The mobile platform image capturing device according to claim 9,
wherein the second stabilization unit has at least one of a first stabilization mechanism for performing blur correction by driving an image capturing sensor, and a second stabilization mechanism for performing blur correction by driving a part of lenses constituting an image capturing optical system for forming an optical image on the image capturing sensor.

16. The mobile platform image capturing device according to claim 15,
wherein when the second stabilization unit has the first stabilization mechanism and the second stabilization mechanism, the first stabilization mechanism and the second stabilization mechanism are targeted for blur correction at different frequency bands in the second stabilization mode, and
the controller controls the frequency bands targeted for blur correction respectively by the first stabilization mechanism and the second stabilization mechanism in accordance with at least one of a movement speed and a movement direction of the mobile platform acquired from the mobile platform.

17. The mobile platform image capturing device according to claim 16,
wherein the controller controls the frequency bands targeted for blur correction respectively by the first stabilization mechanism and the second stabilization mechanism to be higher frequency bands when the movement speed of the mobile platform is higher than a threshold or when a proportion in a lateral direction is higher than a proportion in a front-rear direction in the movement direction of the mobile platform, than when the movement speed of the mobile platform is equal to or lower than the threshold and a component in the front-rear direction is larger than a component in the lateral direction in the movement direction of the mobile platform.

18. A method for controlling an image capturing device which is mountable on a mobile platform having first stabilization unit and has second stabilization unit, the method comprising:
controlling a mode of blur correction by the second stabilization unit to be a first stabilization mode or a second stabilization mode which is targeted for blur correction at a frequency band higher than a frequency band of the first stabilization mode in accordance with at least one of the presence or absence of the image capturing device being mounted on the mobile platform and detected vibration.
